(19) United States
(12) Patent Application Publication
(10) Pub. No.: US 2017/0223581 A1
(43) Pub. Date: Aug. 3, 2017

(54) METHOD AND USER EQUIPMENT FOR RECOVERING SERVICE IN UNIVERSAL MOBILE TELECOMMUNICATIONS SYSTEM (UMTS) NETWORK

(71) Applicant: Samsung Electronics Co., Ltd., Gyeonggi-do (KR)

(72) Inventors: Bhoss A, Bangalore (IN); Prashant Ashok CHITARE, Bangalore (IN); Rajesh Booravalli Seetharama SASTRY, Bangalore (IN); Venkata Subba Rao MANNE, Bangalore (IN)

(73) Assignee: Samsung Electronics Co., Ltd.

(21) Appl. No.: 15/211,649

(22) Filed: Jul. 15, 2016

(30) Foreign Application Priority Data
Jan. 28, 2016 (IN) 201641003105 CS

(51) Int. Cl. H04W 36/00; H04W 56/00; H04W 76/06; H04W 36/08; H04W 74/00

(52) U.S. Cl. CPC H04W 36/0066; H04W 36/08; H04W 36/0061; H04W 74/004; H04W 76/068; H04W 56/0035; H04W 84/042

(57) ABSTRACT

A method and user equipment (UE) for recovering a service in a wireless network is provided. The method includes detecting, in a UE, that a fast cell update criteria is met, and recovering, in the UE, the service in the wireless network by performing a cell update procedure.

### PRIORITY

This application claims priority under 35 U.S.C. §119(a) to an Indian Complete Patent Application Serial No. 201641003105 (CS) which was filed on Jan. 28, 2016 in the Indian Intellectual Property Office, the entire content of which is incorporated herein by reference.

### BACKGROUND

1. Field of the Disclosure

The present application generally relates to a communication system, and more particularly to a mechanism for recovering a service in a wireless network.

2. Description of the Related Art

When a handover is triggered from one cell to another cell in a UMTS network, the UMTS network sends a measurement control message to a user equipment (UE). Based on the measurement control message, the UE performs measurements for neighboring cells in order to trigger the handover to the best cell. In some cases, after the handover is done from one cell to another cell in the UMTS network, the measurement control message is not received from the UMTS network, resulting in the UE not performing the neighbor cell measurements required for triggering the handover. This case leads to out-of-synchronization (OOS) on the UE side and further service degradation may occur.

### SUMMARY

Accordingly, an aspect of the present disclosure provides a method for recovering a service in a UMTS network by triggering a cell update due to a radio link (RL) failure in certain conditions.

Another aspect of the present disclosure provides a method for detecting, in a User Equipment (UE), that a fast cell update criteria is met.

Another aspect of the present disclosure provides a method for recovering, in a UE, a service in a UMTS network by performing a cell update procedure resulting from an RL failure.

Another aspect of the present disclosure provides a method for initiating a timer during a handover procedure.

Another aspect of the present disclosure provides a method for detecting that a measurement configuration message is not received before a timer expires in a UE.

Another aspect of the present disclosure provides a method for detecting, in a UE, that a network entity configures a transport channel with a transport block size, and traffic volume measurement configurations that are unavailable.

Another aspect of the present disclosure provides a method for indicating, in a UE, from a media access control (MAC) layer to a radio resource control (RRC) layer to trigger a cell update procedure to a UMTS network.

Another aspect of the present disclosure provides a method for receiving an enhanced uplink random access control channel (E-RUCCH) transmission failure indicator.

Another aspect of the present disclosure provides a method for detecting that an out-of-synchronization (OOS) timer is active.

Another aspect of the present disclosure provides a method for ignoring an OOS timer and instructing a UE to trigger a cell update procedure with a RL failure in a UMTS network.

According to an aspect of the present disclosure, a method is provided for recovering a service in a wireless network. The method includes detecting, in a user equipment (UE), that a fast cell update criteria is met and recovering, in the UE, the service in the wireless network by performing a cell update procedure.

According to another aspect of the present disclosure, a user equipment (UE) is provided for recovering a service in a wireless network. The UE includes a UE radio resource control (URRC) unit configured to detect that a fast cell update criteria is met and recover the service in the wireless network by performing a cell update procedure.

According to another aspect of the present disclosure, a non-transitory computer readable storage medium in an electronic device is provided for storing instructions thereon, which when executed by at least one processor, instruct the electronic device to detect, in a user equipment (UE), that a fast cell update criteria is met and recover, in the UE, a service in a wireless network by performing a cell update procedure.

### BRIEF DESCRIPTION OF FIGURES

The above and other aspects, features, and advantages of the present disclosure will be more apparent from the following detailed description when taken in conjunction with the accompanying drawings, in which:

FIG. 1 to 3 are flow diagrams illustrating a service drop scenario in a UMTS network, according to the related art;

FIG. 4 is a block diagram of a UE, according to an embodiment of the present disclosure;

FIG. 5 is a flowchart illustrating a method for recovering a service in a UMTS network, according to an embodiment of the present disclosure;

FIG. 6 is a flowchart illustrating a method for recovering a service in a UMTS network, when a measurement configuration message is not received before a timer expires in a UE, according to an embodiment of the present disclosure;

FIG. 7 is a flow diagram illustrating operations to recover a service in a UMTS network, when a measurement configuration message is not received before a timer expires in a UE, according to an embodiment of the present disclosure;

FIG. 8 is a flowchart illustrating a method for recovering a service in a UMTS network, when a UMTS network configures transport channels, according to an embodiment of the present disclosure;

FIG. 9 is a flow diagram illustrating operations to recover a service in a UMTS network, when a UMTS network configures transport, according to an embodiment of the present disclosure;

FIG. 10 is a flowchart illustrating a method to handle multiple RL failures, according to an embodiment of the present disclosure;

FIG. 11 is a flow diagram illustrating operations to handle multiple RL failures, according to an embodiment of the present disclosure; and

FIG. 12 is a block diagram of a computing environment for recovering a service in a UMTS network, according to an embodiment of the present disclosure.

### DETAILED DESCRIPTION

The embodiments disclosed herein and the various features and details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments may be combined with one or more other embodiments to form new embodiments. The term “or” as used herein, refers to a non-exclusive or, unless otherwise indicated. The examples used herein are to facilitate an understanding of ways in which the embodiments herein may be practiced and to further enable those skilled in the art to practice the embodiments herein. Accordingly, the examples should not be construed as limiting the scope of the embodiments herein.

According to an embodiment of the present disclosure, a method for recovering a service in a UMTS network is provided. The method includes detecting, in a UE, that a fast cell update criteria is met. Further, the method includes recovering, in the UE, the service in the UMTS network by performing a cell update procedure.

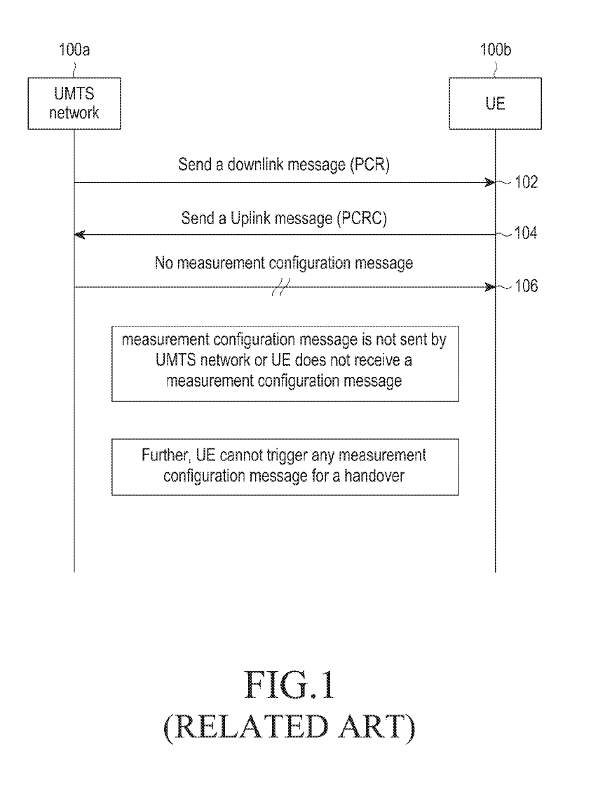

Referring to FIG. 1, the UMTS network 100a sends, at step 102, a downlink message (for example, physical uplink shared channel (PUSCH) capacity request (PCR) message) to the UE 100b. When the UE 100b receives the downlink message, the UE 100b sends an uplink message (for example, physical channel reconfiguration complete (PCRC)) to the UMTS network 100a. The UMTS network 100a does not configure, at step 106, the measurement process after the handover procedure. If the measurement control message is not received from the UMTS network 100a then, the UE 100b may not perform the neighbor cell measurements and no handover may be triggered. This leads to OOS in the UE 100b and further service degradation will occur. The service degradation may be due to a wrong network configuration or the UE 100b may not receive the measurement control message due to poor signal conditions.

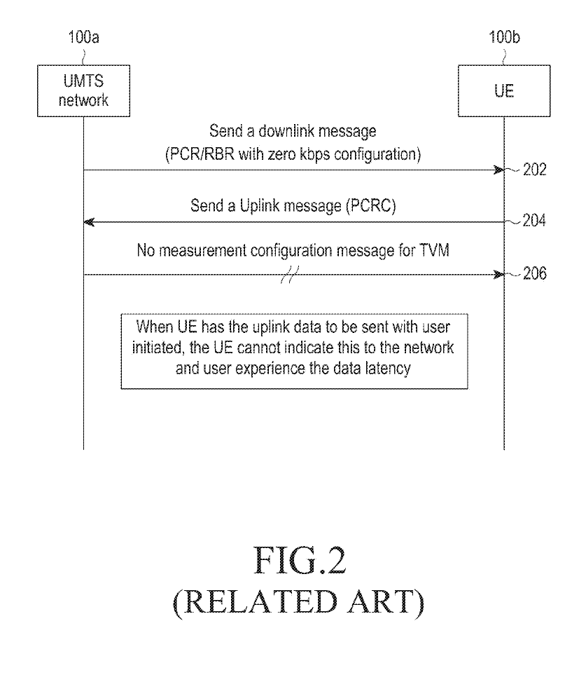

Referring to FIG. 2, during the cell update procedure, the UMTS network 100a sends, at step 202, the downlink message (for example, PCR/RBR (radio bearer reconfiguration) with zero kbps configuration) to the UE 100b. The UE 100b sends, at step 204, the uplink message (for example, PCRC message) to the UMTS network 100a. The UMTS network 100a does not send, at step 206, the measurement configuration message for traffic volume measurement (TVM) to the UE 100b due to the zero Kbps channel configuration between the UMTS network 100a and the UE 100b. This causes the data latency as the UE 100b may not indicate the presence of the uplink data to be sent to the UMTS network 100a. This problem may be due to the wrong network configuration, resulting in service degradation in the UMTS network 100a.

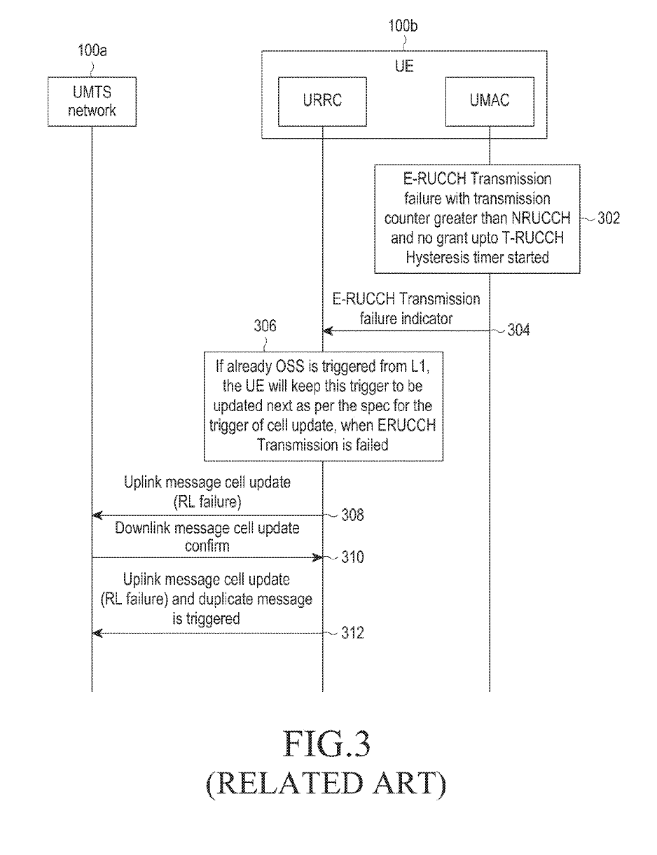

Referring to FIG. 3, when an enhanced dedicated channel (E-DCH) random access uplink control channel (E-RUCCH) transmission counter is added, at step 302, and is greater than a N-RUCCH (number of retransmissions in an enhanced dedicated channel (E_DCH) random access uplink control channel), a hysteresis timer with the value of T-RUCCH (timeout for retransmission in E_DCH random access uplink control channel) timer is started, upon the hysteresis timer expiring, and no grant has been received for the whole duration, and also a radio link (RL) failure is triggered due to an OOS procedure from layer 1, the user equipment media access control (UMAC) unit sends, at step 304, the E-RUCCH transmission failure indicator to the URRC unit. The URRC unit receives the E-RUCCH transmission failure indicator. The URRC unit detects, at step 306, that the OOS timer is active and ignores the OOS timer. The URRC unit, at step 308, triggers the cell update procedure due to the RL failure to the UMTS network 100a. The UMTS network 100a sends, at step 310, the downlink message including the cell update confirm message. In this case, the RL failure is processed as per the UMTS network 100a specification, and the cell update is triggered, but also the event trigger for the E-RUCCH (E-DCH random access uplink control channel) failure as per the UMTS network 100a specification causes, at step 312, the duplicate cell update trigger. This results in a redundant cell update processing and consumes more signaling message exchange events as shown in FIG.3.

Unlike conventional systems and methods, the fast cell update criteria is used for fast radio link (RL) recovery in a UMTS network. The fast radio link recovery is achieved by triggering the cell update caused by the RL failure in certain conditions.

RL failure is triggered in the UMTS network so that the UMTS network will send the response with a cell update confirmation message in the downlink (DL). With the cell update confirmation message in the DL, the UE may recover from the dropped call and data latency issues quickly.

In an embodiment of the present disclosure, detecting the fast cell update criteria is met includes initiating a timer during a handover procedure, and detecting that the measurement configuration message is not received before the timer expires in the UE.

In an embodiment of the present disclosure, detecting that the fast cell update criteria is met includes detecting that a network entity configures a transport channel with a transport block size, traffic volume measurement configurations are unavailable, and a MAC layer indicating to a RRC layer to trigger the cell update procedure in the UMTS network.

In an embodiment of the present disclosure, the method may be used to provide a recovery mechanism in layer 2/layer 3 (L2/L3) protocol layers. The method may be used to avoid the data latency issues when a UMTS network configures transport channels with a transport block size or number of transport blocks as zero. The method results in improving user experience in webpage browsing and multimedia streaming services. The proposed method may also be used to improve data transfer speeds.

In an embodiment of the present disclosure, detecting that the fast cell update criteria is met includes receiving an E-RUCCH transmission failure indicator, detecting that an OOS timer is active, ignoring the OOS timer, and instructing the UE to trigger the cell update procedure with RL failure in a UMTS network.

In an embodiment of the present disclosure, the method may be used to avoid redundant cell update processing and reduce signaling message exchanges between the UE and the UMTS network. Thereby, reducing UE battery power consumption. The method may be used to handle the multiple RL failure scenario when the OOS has occurred and the E-RUCCH transmission has failed, in order to avoid the multiple cell update procedures in the UE.

In an embodiment of the present disclosure, the method may be used to reduce call drops and improve a data recovery procedure in a wireless network. In an embodiment of the present disclosure. The wireless network may be a network corresponding to protocols including time division synchronous code division multiple access (TD-SCDMA), long term evolution (LTE), long term evolution advanced (LTE-A), time division long term evolution (TD-LTE) and universal mobile telecommunications system (UMTS) networks.

In describing the drawings, similar reference numerals may be used to designate similar constituent elements.

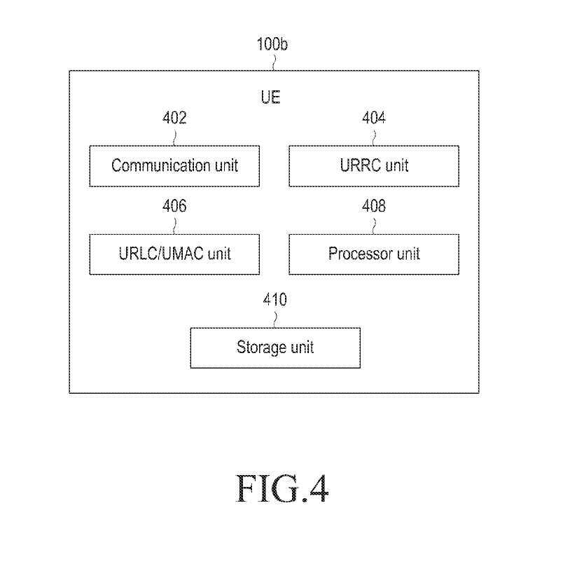

FIG. 4 is a block diagram of a UE, according to an embodiment of the present disclosure

According to an embodiment of the present disclosure, a UE may be a cellular phone, a smart phone, a session initiation protocol (SIP) phone, a satellite radio, a laptop, a personal digital assistant (PDA), a video device, a global positioning system, a game console, a multimedia device, a tablet, or any other similar device. A UE may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, and the like.

Referring to FIGS. 2 and 4, a UE 100b includes a communication unit 402, a URRC unit 404, a UE radio link control (URLC)/UE media access control (UMAC) unit 406 (URLC/UMAC), a processor unit 408, and a storage unit 410. The communication unit 402 is configured to send a signaling message to the UMTS network 100a. Further, the communication unit 402 is configured for communicating between internal units and with external devices via one or more networks. The URRC unit 404 is configured to detect that the fast cell update criteria is met.

After detecting that the fast cell update criteria is met, the URRC unit 404 is configured to perform the cell update procedure. Based on the cell update procedure, the processor unit 408 is configured to recover the service in the UMTS network 100a. The service may be, for example, but is not limited to a voice call, an emergency call, a video call, a conference call, a data service, a multimedia service, a webpage browsing service, a multimedia service and the like.

The fast cell update criteria is used for fast radio link recovery in the UMTS network 100a. The fast RL recovery is achieved by triggering the cell update caused by RL failure in certain conditions. When the cell update due to RL failure is triggered in the network, the network will send the response with a cell update confirmation message in the downlink (DL). With the cell update confirmation message in the DL, the UE 100b may recover the dropped call and data latency issues quickly.

According to an embodiment of the present disclosure, in order to detect that the cell update criteria is met, the URRC unit 404 is configured to initiate the timer during the handover procedure. Further, the URRC unit 404 is configured to detect that the measurement configuration message is not received before the timer expires in the UE 100b. After detecting that the measurement configuration message is not received before the timer expires in the UE 100b, the processor unit 408 is configured to recover the service in the UMTS network 100a, by performing the cell update procedure.

According to an embodiment of the present disclosure, in order to detect that the cell update criteria is met, the URRC unit 404 is configured to detect that the UMTS network 100a configures a transport channel with a transport block size of zero, and traffic volume measurement configurations are unavailable. The URLC/UMAC unit 406 is configured to indicate from a media access control (MAC) layer to a radio resource control (RRC) layer to trigger the cell update procedure in the UMTS network 100a. Based on the cell update procedure, the processor unit 408 is configured to recover the service in the UMTS network 100a.

According to an embodiment of the present disclosure, in order to detect that the cell update criteria is met, the URLC/UMAC unit 406 is configured to send an E-RUCCH transmission failure indicator message to the URRC unit 404. The URRC unit 404 is configured to receive the E-RUCCH transmission failure indicator message. Further, the URRC unit 404 is configured to detect that an OOS timer is active. Further, the URRC unit 404 is configured to ignore the OOS timer and trigger the cell update procedure due to the RL failure in the UMTS network 100a. Based on the cell update procedure with the RL failure in the UMTS network 100a, the processor unit 408 is configured to recover the service in the UMTS network 100a.

The storage unit 410 may include one or more computer-readable storage media. The storage unit 410 may include non-volatile storage elements. Examples of such non-volatile storage elements include magnetic hard disc, optical discs, floppy discs, flash memories, or forms of electrically programmable memories (EPROM) or electrically erasable and programmable (EEPROM) memories. In addition, the storage unit 410 may be considered a non-transitory storage medium. However, the term “non-transitory” should not be interpreted that the storage unit 410 is non-movable. The storage unit 410 may be configured to store larger amounts of information than a memory. A non-transitory storage medium may store data that may, over time, change (e.g., in random access memory (RAM) or cache memory).

Although FIG. 4 illustrates an example of the UE 100b, it is to be understood that other embodiments are not limited thereto. In other embodiments, the UE 100b may include more or less number of units. Further, the labels or names of the units are used for illustrative purposes and do not limit the scope of the disclosure. One or more units may be combined together to perform the same or substantially similar functions to recover the service in the UMTS network 100a.

FIG. 5 is a flowchart illustrating a method for recovering a service in a UMTS network, according to an embodiment of the present disclosure.

Referring to FIG. 5, at step 502, the method includes detecting that the fast cell update criteria is met. In an embodiment of the present disclosure, the method includes the URRC unit 404 detecting that the fast cell update criteria is met. At step 504, the method includes performing the cell update procedure due to radio link failure. The URRC unit 404 may perform the cell update procedure due to radio link failure. At step 506, the method includes recovering the service in the UMTS network 100a. The processor unit 408 may recover the service in the UMTS network 100a.

The method may be used to achieve a quick RL recovery by triggering the cell update due to RL failure in certain conditions. The method may be used to improve the user experience during voice calls, web browsing and the like. The method may be used to reduce call dropping and improve the data recovery procedure in UMTS and TD-SCDMA networks.

The various actions, acts, blocks, steps, and the like in the method may be performed in the order presented, in a different order or simultaneously. Further, in some embodiments, some of the actions, acts, blocks, steps, and the like may be omitted, added, modified, or skipped without departing from the scope of the present disclosure.

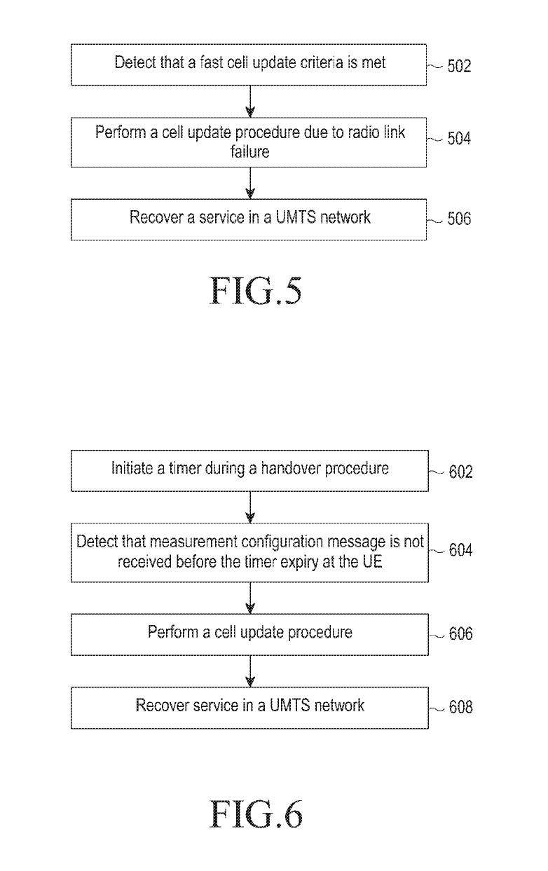

FIG. 6 is a flowchart illustrating a method for recovering a service in a UMTS network, when a measurement configuration message is not received before a timer expires in a UE, according to an embodiment of the present disclosure.

Referring to FIG. 6, at step 602, the method includes initiating a timer during a handover procedure. In an embodiment of the present disclosure, the URRC unit 404 initiates the timer during the handover procedure. At step 604, the method includes detecting that measurement configuration message is not received before the timer expires in the UE 100b. In an embodiment, the method 600 allows the URRC unit 404 to detect that a measurement configuration message is not received before a timer expires in the UE 100b. At step 606, the method includes performing the cell update procedure. The URRC unit 404 may perform the cell update procedure. At step 608, the method includes recovering the service in the UMTS network 100a. The processor unit 408 may recover the service in the UMTS network 100a.

During the handover procedure, the UE 100b starts the timer (for example, TMCWaitTimer) for 5 seconds in an N-frequency case (where multiple frequency bands are used within one cell) if the UMTS network 100a does not configure the measurement process after the handover. After the timer expires, the UE 100b triggers the cell update procedure due to the RL failure while the UE is mobile. The method may provide fast radio link recovery, so as to avoid service drops in the UMTS network 100a.

The various actions, acts, blocks, steps, and the like in the method may be performed in the order presented, in a different order or simultaneously. Further, in some embodiments, some of the actions, acts, blocks, steps, and the like may be omitted, added, modified, or skipped without departing from the scope of the disclosure.

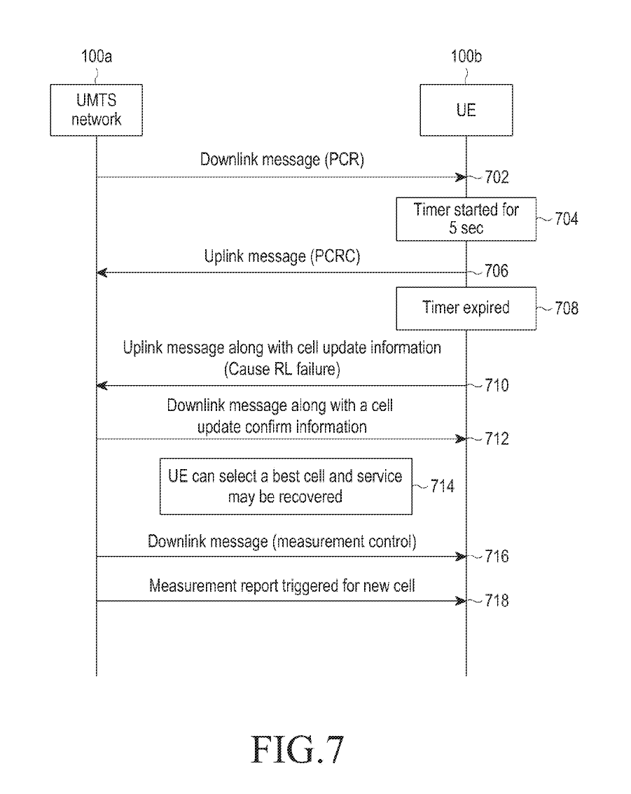

FIG. 7 is a flow diagram illustrating operations for recovering a service in a UMTS network, when a measurement configuration message is not received before a timer expires in a UE, according to an embodiment of the present disclosure.

Referring to FIG. 7, when the UMTS network 100a does not configure the measurement process after the handover procedure, the UMTS network 100a sends, at step 702, the downlink message (for example, a PUSCH capacity request (PCR) message) to the UE 100b. When the UE 100b receives the downlink message, the UE 100b starts, at step 704, the timer (for example, TMCWaitTimer) for 5 seconds. Meanwhile, the UE 100b sends, at step 706, the uplink message (for example, a PCRC message) to the UMTS network 100a. After the timer expires, at step 708, the UE 100b triggers, at step 710, the cell update procedure due to the RL failure. If the UMTS network 100a configures the measurement process, the UE 100b stops the timer, and the normal procedure is continued. Based on the cell update procedure due to the RL failure, the UMTS network 100a sends, at step 712, the downlink message along with a cell update confirm message. Based on the downlink message along with the cell update confirm message, the UE 100b selects, at step 714, the best cell, so that the service may be recovered in the UMTS network 100a. Further, the UMTS network 100a sends, at step 716, the downlink message including a measurement control report. Based on the measurement control report, the UE 100b performs, at step 718, the cell update procedure to recover the service in the UMTS network 100a. The method may be used to provide fast radio link recovery to avoid service drops in the UMTS network 100a.

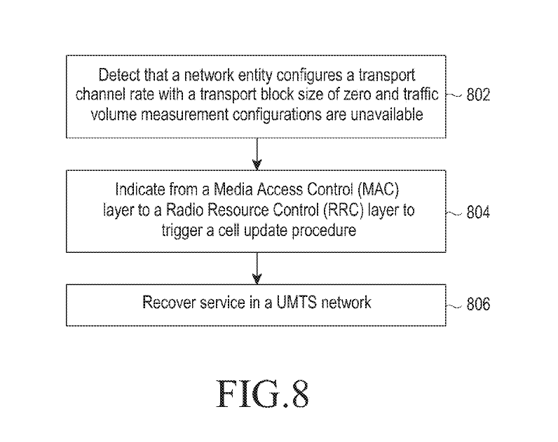

FIG. 8 is a flowchart illustrating a method for recovering a service in a UMTS network, when a UMTS network configures transport channels, according to an embodiment of the present disclosure.

FIG. 8 is a flowchart illustrating a method for recovering the service in the UMTS network 100a, when the UMTS network 100a configures the transport channels as zero kbps and the UE 100b does not have traffic volume measurements (TVM) for the event 4a. The event 4a relates to when a transport channel traffic volume becomes larger than an absolute threshold. At step 802, the method includes detecting that the network entity (for example, UMTS network 100a) configures the transport channel rate as zero kbps with the transport block size of zero and traffic volume measurement configurations are unavailable. The URRC unit 404 may detect that the network entity configures the transport channel rate as zero kbps with the transport block size of zero and traffic volume measurement configurations are unavailable. At step 804, the method includes indicating from the MAC layer to the RRC layer to trigger the cell update procedure. The URRC unit 404 may indicate from the MAC layer to the RRC layer to trigger the cell update procedure. At step 806, the method includes recovering the service in the UMTS network 100a. The processor unit 408 may recover the service in the UMTS network 100a.

In an embodiment of the present disclosure, when the UMTS network 100a configures the transport channels with transport block size or number of transport blocks as zero, whose rate is determined by the number of transport blocks*transport block size=zero kbps, and when the UE 100b doesn't have traffic volume measurement configurations, then the L2 layer will indicate to the L3 layer to trigger a signaling connection release indication (SCRI) to the UMTS network 100a for the packet switched (PS) domain. When the SCRI is sent to the UMTS network 100a, the UMTS network 100a will release the existing PS connection and will remove all packet switched radio access bearers (PS RABs). When the L3 layer triggers the service request (for example, uplink data), a new PS connection will be established which may prevent the data latency issue.

In an embodiment of the present disclosure, when the UMTS network 100a configures the transport channels with the transport block size or number of transport blocks as zero, whose rate is determined by the number of transport blocks*transport block size=zero kbps and when the UE 100b doesn't have the traffic volume measurement configurations, then the L2 layer will indicate to the L3 layer to trigger the cell update procedure to the UMTS network 100a. When the cell update procedure is sent to the UMTS network 100a, the UMTS network 100a will send new configurations in the cell update confirm message for existing PS RABs.

In an embodiment of the present disclosure, when the UMTS network 100a configures the zero kbps transport channel and if the TVM is configured, then the L2 layer will indicate to the L3 layer to trigger the cell update procedure to the UMTS network 100a. When the cell update procedure is sent to the UMTS network 100a, the UMTS network 100a will send new configurations in the cell update confirm message for the existing PS RABs.

In the case radio where radio bearers in the PS domain are mapped on the transport channel whose rate is zero kbps, for which the TVM configuration is not present, the user will experience data latency problems. In an embodiment of the present disclosure, the MAC layer will indicate the transport channel configuration to the RRC layer, so as to trigger the cell update procedure to the UMTS network 100a. Based on the cell update procedure request from the RRC layer, the UMTS network 100a sends the new configuration message in the cell update confirm message for the existing PS RABs. Thus, avoiding the data latency problem and enhancing the user experience.

The method may be used to provide the service recovery mechanism in the L2/L3 protocol layers. The method may be used to avoid the data latency issues when the UMTS network 100b configures the transport channels with transport block size or number of transport blocks as zero. Thus, improving the webpage browsing experience and the multimedia service experience.

The various actions, acts, blocks, steps, and the like, in the method may be performed in the order presented, in a different order or simultaneously. Further, in some embodiments of the present disclosure, some of the actions, acts, blocks, steps, and the like may be omitted, added, modified, or skipped without departing from the scope of the disclosure.

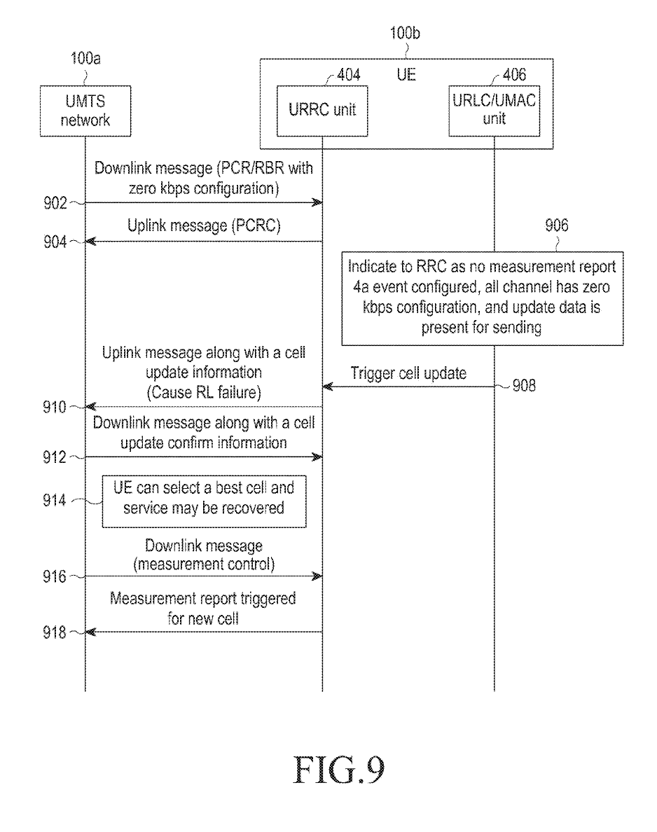

FIG. 9 is a flow diagram illustrating operations to recover a service in a UMTS network, when a UMTS network configures transport, according to an embodiment of the present disclosure.

Referring to FIG. 9, the operations illustrated are performed for recovering the service in the UMTS network 100a, when the UMTS network 100a configures the transport channel rate as zero kbps and the UE 100b does not have the traffic volume measurements for the event 4a. The UMTS network 100a sends, at step 902, the downlink message (for example, PCR/RBR with zero kbps configuration) to the URRC unit 404 in the UE 100b. The URRC unit 404 sends, at step 904, the uplink message (for example, PCRC message) to the UMTS network 100a. The URLC/UMAC unit 406 in the UE 100b indicates, at step 906, to the RRC that the UE 100b does not have the TVM configured (event 4a), when the UMTS network 100a configures the transport channel rate as zero kbps to the UE 100b. The event 4a relates to when the transport channel traffic volume becomes larger than an absolute threshold. Further, the URLC/UMAC unit 406 triggers, at step 908, the cell update procedure to the URRC unit 404. Based on the cell update trigger procedure from the URLC/UMAC unit 406, the URRC unit 404 sends, at step 910, the uplink message including the cell update request along with the RL failure information. When the cell update request is sent to the UMTS network 100a, the UMTS network 100a sends, at step 912, the downlink message including new configurations in the cell update confirm message for existing PS RABs.

Based on the downlink message along with the cell update confirm message, the UE 100b selects, at step 914, the best cell, so that the service may be recovered in the UMTS network 100a. Further, the UMTS network 100a sends, at step 916, the downlink message including the measurement control report. Based on the measurement control report, the UE 100b performs, at step 918, the cell update procedure to recover the service in the UMTS network 100a. The method provides fast radio link recovery to avoid the data latency problem in the UMTS network 100a.

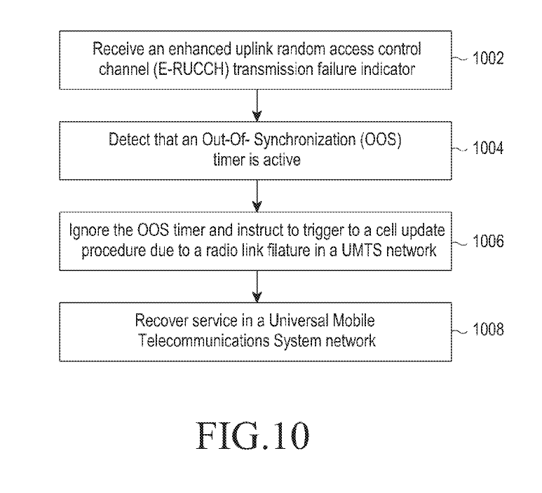

FIG. 10 is a flowchart illustrating a method to handle multiple RL failures, according to an embodiment of the present disclosure.

Referring to FIG. 10, the flowchart illustrates a method to handle multiple RL failures when the OOS has occurred and the E-RUCCH transmission has failed. The scenario occurs when the E-RUCCH transmission counter is added and is greater than N-RUCCH, a hysteresis timer with a value of T-RUCCH time is started, upon the hysteresis timer expiring and no grant has been received for the whole duration, and the RL failure is triggered due to the OOS procedure from the layer 1. At step 1002, the method includes receiving the E-RUCCH transmission failure indicator. The URRC unit 404 may receive the E-RUCCH transmission failure indicator. At step 1004, the method includes detecting that the OOS timer is active. The URRC unit 404 may detect that the OOS timer is active. At step 1006, the method includes ignoring the OOS timer and triggering the cell update procedure due to RL failure in the UMTS network 100a. The URRC unit 404 may ignore the OOS timer and trigger the cell update procedure due to radio link failure in the UMTS network 100a. At step 1008, the method includes recovering the service in the UMTS network 100a. The URRC unit 404 may recover the service in UMTS network 100a.

The method may be used to avoid redundant cell update processing and reduce the signaling message exchange between the UE 100b and the UMTS network 100a. Thereby, reducing the UE 100b battery power consumption. The method may be used to handle the multiple RL failure scenario when the OOS has occurred and the E-RUCCH transmission has failed, so as to avoid the multiple cell update procedures.

The various actions, acts, blocks, steps, and the like in the method may be performed in the order presented, in a different order or simultaneously. Further, in some embodiments, some of the actions, acts, blocks, steps, or the like may be omitted, added, modified or skipped without departing from the scope of the disclosure.

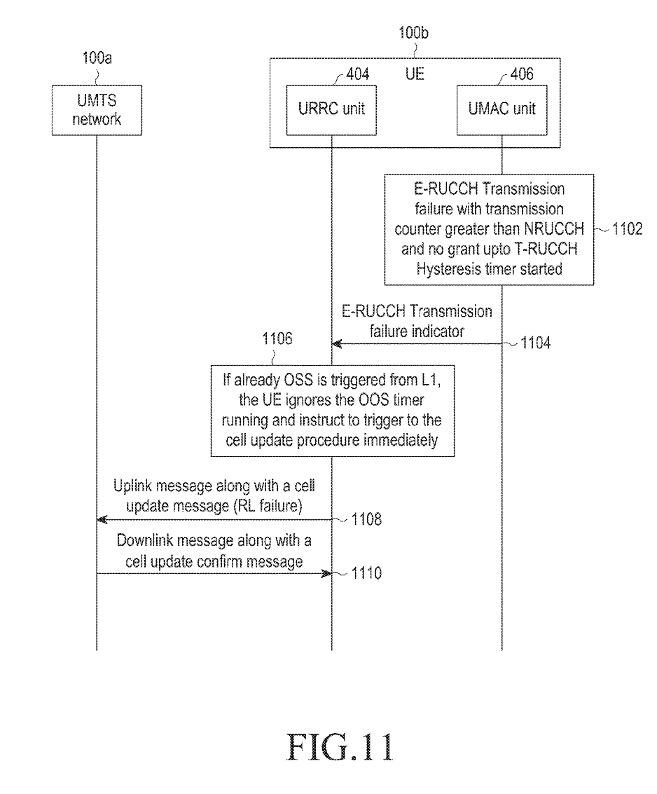

FIG. 11 is a flow diagram illustrating operations to handle multiple RL failures, according to an embodiment of the present disclosure.

Referring to FIG. 11, a flow diagram illustrates operations performed to handle multiple RL failure scenario when OOS has occurred and the E-RUCCH transmission has failed. The scenario occurs when an E-RUCCH transmission counter is added and is greater than N-RUCCH, a hysteresis timer with a value of T-RUCCH time is started, upon the hysteresis timer expiring and no grant has been received for the whole duration, and the RL failure is triggered due to the OOS procedure from the layer 1.

When the E-RUCCH transmission counter is added, in step 1102, and is greater than the N-RUCCH, and the hysteresis timer with the value of T-RUCCH time is started, upon the hysteresis timer expiring, and no grant has been received for the whole duration and also the RL failure is triggered due to the OOS procedure from the Layer 1, the UMAC unit 406 sends, at step 1104, the E-RUCCH transmission failure indicator to the URRC unit 404. The URRC unit 404 receives the E-RUCCH transmission failure indicator. The URRC unit 404 detects, at step 1106, that the OOS timer is active, and ignores the OOS timer. The URRC unit 404, at step 1108, triggers the cell update procedure due to RL failure to the UMTS network 100a. The UMTS network 100a sends, at step 1110, the downlink message including the cell update confirm message.

The method may be used to avoid redundant cell update processing and reduce the signaling message exchange between the UE 100b and the UMTS network 100a.

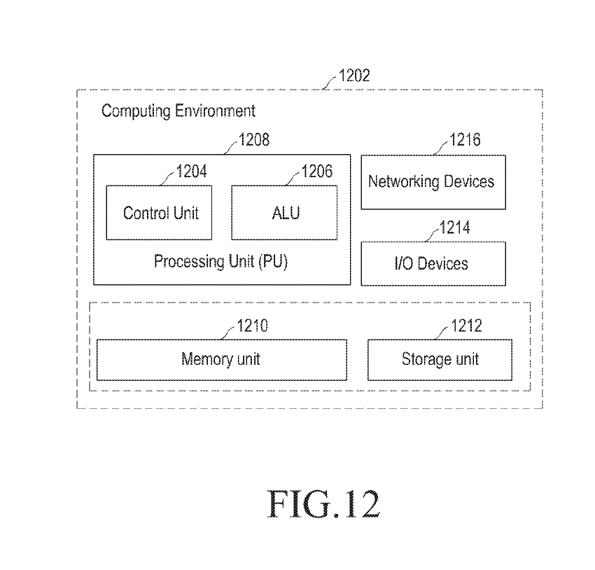

FIG. 12 is a block diagram of a computing environment for recovering a service in a UMTS network, according to an embodiment of the present disclosure.

Referring to FIG. 12, the computing environment 1202 includes at least one processing unit 1208 that is equipped with a control unit 1204, an arithmetic logic unit (ALU) 1206, a memory unit 1210, a storage unit 1212, a plurality of networking devices 1216 and a plurality of input/output (I/O) devices 1214. The processing unit 1208 is responsible for processing the instructions of the present method. The processing unit 1208 receives commands from the control unit 1204 in order to perform the processing. Further, any logical and arithmetic operations involved in the execution of the instructions are computed in the ALU 1206.

The computing environment 1202 may include multiple homogeneous or heterogeneous cores, multiple CPUs of different type, special media and other processing accelerators. Further, the plurality of processing units 1204 may be disposed on a single chip or on multiple chips.

The method including instructions and codes required for implementation of the method are stored in either the memory unit 1210 or the storage unit 1212 or both. At the time of execution, the instructions may be fetched from the corresponding memory 1210 or storage 1212, and executed by the processing unit 1208.

Various networking devices 1216 or I/O devices 1214 may be connected to the computing environment 1202 to support the implementation.

The embodiments disclosed herein may be implemented through at least one software program running on at least one hardware device and performing network management functions to control the elements. The elements shown in FIGS. 4 to 12 include blocks, elements, actions, acts, steps, and the like which may be at least one of a hardware device, a software module, or a combination of hardware device and software module.

The foregoing description of the specific embodiments describe the general nature of the embodiments herein that others may, by applying current knowledge, readily modify and/or adapt for various applications. Such adaptations and modifications are within the meaning and range of equivalents of the disclosed embodiments. It is to be understood that the phraseology or terminology employed herein is for the purpose of description and not of limitation. Accordingly, the scope of the present disclosure should be construed as including all modifications or various other embodiments based on the technical idea of the present disclosure as defined by the following claims and their equivalents

What is claimed is:

1. A method for recovering a service in a wireless network, the method comprising:
detecting, in a user equipment (UE), that a fast cell update criteria is met; and
recovering, in the UE, the service in the wireless network by performing a cell update procedure.

2. The method of claim 1, wherein detecting, in the UE, that the fast cell update criteria is met comprises:
initiating a timer during a handover procedure; and
detecting that a measurement configuration message is not received before the timer expires in the UE.

3. The method of claim 2, wherein a period of the timer is between 4 and 6 seconds.

4. The method of claim 2, wherein, if the wireless network configures a measurement process, the UE stops the timer.

5. The method of claim 1, wherein the wireless network sends a downlink message including a measurement control report.

6. The method of claim 1, wherein detecting, in the UE, that the fast cell update criteria is met comprises:
detecting, in the UE, that a network entity configures a transport channel with a transport block size;
detecting that traffic volume measurement configurations are unavailable; and
indicating, in the UE, from a media access control (MAC) layer to a radio resource control (RRC) layer, to trigger the cell update procedure to the wireless network.

7. The method of claim 6, wherein the MAC layer indicates to the RRC layer to trigger a signaling connection release indication (SCRI) to the wireless network for a packet switched (PS) connection and the wireless network releases the PS connection.

8. The method of claim 6, wherein the transport channel is configured with a transport block size of zero.

9. The method of claim 1, wherein detecting, in the UE, that the fast cell update criteria is met comprises:
receiving an enhanced uplink random access control channel (E-RUCCH) transmission failure indicator message;
detecting that an out-of-synchronization (OOS) timer is active; and
ignoring the OOS timer and triggering the cell update procedure due to a radio link failure in the wireless network.

10. The method of claim 9, wherein when an E-RUCCH transmission counter is added and is greater than a number of retransmissions in an enhanced dedicated channel (E_DCH) random access uplink control channel (N-RUCCH), a hysteresis timer with a period of a timeout for retransmission in E_DCH random access uplink control channel (T-RUCCH) is started.

11. The method of claim 10, wherein when the hysteresis timer expires and no grant has been received for the timer period, a media access control (MAC) layer sends the E-RUCCH transmission failure indicator message to a radio resource control (RRC) layer.

12. The method of claim 9, wherein the E-RUCCH transmission failure indicator message is received by a UE radio resource control (URRC) unit.

13. The method of claim 1, wherein the wireless network is at least one of time division synchronous code division multiple access (TD-SCDMA), long term evolution (LTE), long term evolution advanced (LTE-A), time division long term evolution (TD-LTE) and universal mobile telecommunications system (UMTS).

14. A user equipment (UE) for recovering a service in a wireless network, the UE comprising;
a UE radio resource control (URRC) unit configured to:
detect that a fast cell update criteria is met; and
recover the service in the wireless network by performing a cell update procedure.

15. The UE of claim 14, wherein detecting that the fast cell update criteria is met comprises:
initiating a timer during a handover procedure; and
detecting that a measurement configuration message is not received before the timer expires in the UE.

16. The UE of claim 14, wherein detecting that the fast cell update criteria is met comprises:
detecting that a network entity configures a transport channel with a transport block size; detecting that traffic volume measurement configurations are unavailable; and
indicating from a media access control (MAC) layer to a radio resource control (RRC) layer to trigger the cell update procedure to the wireless network.

17. The UE of claim 16, wherein the transport channel is configured with a transport block size of zero.

18. The UE of claim 14, wherein detecting that the fast cell update criteria is met comprises:
receiving an enhanced uplink random access control channel (E-RUCCH) transmission failure indicator;
detecting that an out-of-synchronization (OOS) timer is active; and
ignoring the OOS timer and triggering the cell update procedure due to a radio link failure in the wireless network.

19. The UE of claim 14, wherein the UE further comprises at least one of a communication unit, a UE radio link control/UE medium access control (URLC/UMAC) unit, a processor unit, and a storage unit.

20. A non-transitory computer readable storage medium in an electronic device for storing instructions thereon, which when executed by at least one processor, instruct the electronic device to:
detect, in a user equipment (UE), that a fast cell update criteria is met; and
recover, in the UE, a service in a wireless network by performing a cell update procedure.
